(19) United States
(12) Patent Application Publication
(10) Pub. No.: US 2013/0105529 A1
(43) Pub. Date: May 2, 2013

(54) Accessory Pack For Footwear

(71) Applicant: Matthew N. Simmons, Littleton, CO (US)

(72) Inventor: Matthew N. Simmons, Littleton, CO (US)

(21) Appl. No.: 13/287,479

(22) Filed: Nov. 2, 2011

(51) Int. Cl. A45F 5/00; B23P 11/00

(52) U.S. Cl. 224/191; 29/428

(57) ABSTRACT

An accessory pack for attaching to a footwear apparatus, the accessory pack comprising a backbone configured for fitting under a fastening mechanism of the footwear apparatus, a pouch having an interior volume configured to receive one of more accessories, the pouch coupled to a first end of the backbone, and a hood coupled to a second end of the backbone, the hood configured for maintaining the one or more accessories in the pouch when the hood is folded over and attached to the pouch.

### BACKGROUND OF THE INVENTION

Persons skiing, snowboarding, hiking, camping, backpacking, mountain climbing and the like often carry many accessories while participating in such sporting activities. Such accessories are stored in a variety of places such as jackets, pockets, fanny packs, and backpacks to name a few. Fluids, such as water, juice, energy drinks, and electrolyte replenishment drinks, may be stored in a backpack style liquid container such as a Camelback™, bottles, canteens or other apparatuses. It is often undesirable or difficult to access the accessories and fluids from the traditional locations listed above. Additionally, the above-mentioned apparatuses are all located against or attached to a person's upper body or hips. During activities such as skiing, snowboarding and mountain climbing, such accessory storage apparatuses hinder upper body movement. Further, if a person is participating in a sporting activity with children, it can become increasingly difficult to carry additional accessories or fluids for one or more children.

As such, an apparatus would be useful that is capable of providing a convenient means of storing accessories or fluids, while overcoming the limitations described above.

### SUMMARY OF THE INVENTION

An accessory pack for attaching to a footwear apparatus is disclosed. The accessory pack comprises a backbone, which is configured for fitting under a fastening mechanism of the footwear apparatus. The accessory pack further comprises a pouch having an interior volume configured to receive one of more accessories. The pouch coupled to a first end of the backbone. The accessory pack further comprises a hood coupled to a second end of the backbone, wherein the hood is configured for maintaining the one or more accessories in the pouch when the hood is folded over and attached to the pouch.

A method for manufacturing an accessory pack for attaching to a footwear apparatus is disclosed. The method comprises a step of introducing a molding material into a tooling apparatus to create a molded part, wherein the tooling apparatus comprises a core and a cavity. The core aligns with the cavity by a polarity of pins. The molded part comprises a backbone configured for fitting under a fastening mechanism of the footwear apparatus, a pouch having an interior volume configured to receive one of more accessories, the pouch coupled to a first end of the backbone, and a hood coupled to a second end of the backbone. The hood is configured for maintaining the one or more accessories in the pouch when the hood is folded over and attached to the pouch.

A method for manufacturing an accessory pack for attaching to a footwear apparatus is disclosed. The method comprises a step of introducing a first molding material into a first tooling apparatus to create a first molded part, wherein the first tooling apparatus comprises a first core and a first cavity. The first core aligns with the first cavity by a first polarity of pins. The first molded part comprises a backbone configured for fitting under a fastening mechanism of the footwear apparatus, wherein the first molded part has a first Durometer rating. The method comprises another step of introducing a second molding material into a second tooling apparatus to create a second molded part, wherein the second tooling apparatus comprising a second core and a second cavity. The second core aligns with the second cavity by a second polarity of pins. The second molded part comprises a pouch having an interior volume configured to receive one or more accessories, wherein the pouch coupled to a first end of the backbone. The second molded part further comprises a hood coupled to a second end of the backbone, wherein the hood configured for maintaining the one or more accessories in the pouch when the hood is folded over and attached to the pouch. The second molded part has a second Durometer rating different than the first Durometer rating. The second molded part is over-molded on the first molded part.

### BRIEF DESCRIPTION OF THE DRAWINGS

A further understanding of the nature and advantages of the present invention may be realized by reference to the figures, which are described in the remaining portion of the specification. In the figures, like reference numerals are used throughout several figures to refer to similar components. In some instances, a reference numeral may have an associated sub-label consisting of a subscript to denote one of multiple similar components. When reference is made to a reference numeral without specification of a sub-label, the reference is intended to refer to all such multiple similar components.

FIG. 1 illustrates a perspective view of an accessory pack coupled to ski boot.

FIG. 2 illustrates a close-up view of an accessory pack coupled to buckles of a ski boot.

FIG. 3 illustrates a different perspective view of an accessory pack coupled to a ski boot.

FIG. 4A illustrates a perspective view of an accessory pack and a plurality of features described therein.

FIG. 4B illustrates a close-up view of a backbone extending into a pouch.

FIG. 5 illustrates a different perspective view of an accessory pack and a plurality of features.

FIG. 6 illustrates a perspective view of a closed accessory pack.

FIG. 7 illustrates a perspective view of a closed accessory pack coupled to a ski boot.

FIG. 8 illustrates a perspective view of an accessory pack securing a water bottle, while coupled to a ski boot.

FIG. 9 illustrates a different perspective view of an accessory pack securing a water bottle, while coupled to a ski boot.

FIG. 10 is a flowchart describing one embodiment for manufacturing an accessory pack.

FIG. 11 is a flowchart describing one embodiment for manufacturing an accessory pack.

### DETAILED DESCRIPTION

In the following description, for the purposes of explanation, numerous specific details are set forth in order to provide a thorough understanding of the present invention. It will be apparent, however, to one skilled in the art that the present invention may be practiced without some of these specific details. For example, while various features are ascribed to particular implementations, it should be appreciated that the features described with respect to one implementation may be incorporated with other implementations as well. By the same token, however, no single feature or features of any described implementation should be considered essential to the invention, as other implementations of the invention may omit such features.

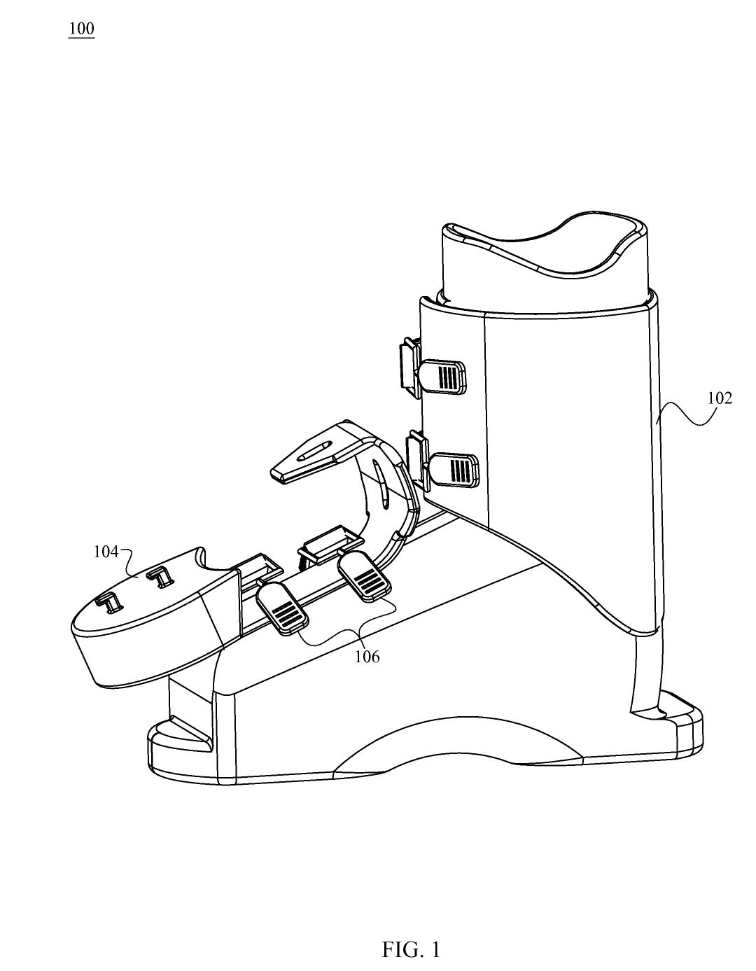

FIG. 1 illustrates a perspective view 100 of an accessory pack coupled to a ski boot. In this view, an accessory pack 104 couples to a ski boot 102 having a plurality of buckles 106 useful for positioning and maintaining a user's lower leg and foot inside the ski boot 102. Additionally, one or more of the buckles 106 may be useful for maintaining the accessory pack 104 against the ski boot 102 in one or more positions as depicted in FIG. 1. In another embodiment, the accessory pack 104 may couple to a single buckle or more than two buckles. In another embodiment , the ski boot 102 may use a different fastening mechanism, other than buckles, such as laces, draw strings, and wire clamps, to name a few. As such, the accessory pack 104 may also couple to the ski boot 102 through differing fastening mechanisms than illustrated in FIG. 1, without deviating from the scope of the invention. In another embodiment, the accessory pack 104, may also be used with and coupled to different footwear such as snowboarding boots, hiking boots, military boots, and sneakers, to name a few. In such an embodiment, the accessory pack 104 may be coupled to the footwear by laces; since footwear do not normally use buckles. Other footwear examples may be contemplated without deviating from the scope of the invention.

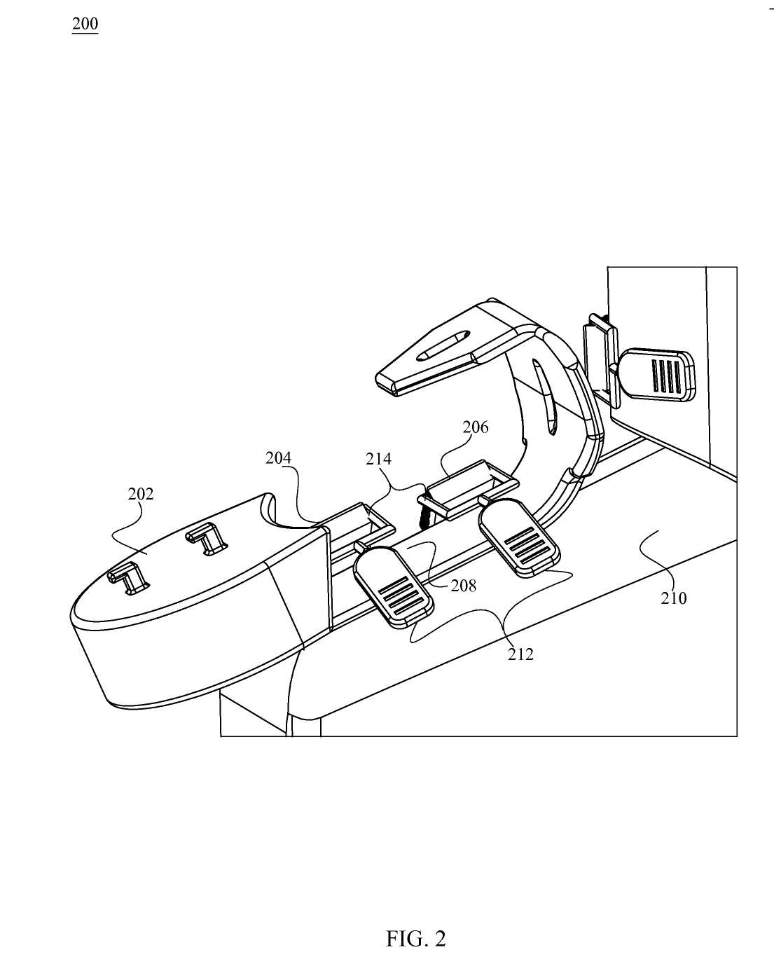

FIG. 2 illustrates a close-up view 200 of an accessory pack coupled to buckles of a ski boot. In this view, an accessory pack 202 is coupled to a first buckle 204 and a second buckle 206 of a ski boot 210. In one embodiment, a backbone portion 208 of the accessory pack 202 is the coupling point whereby the buckles 204 and 206 make contact with the accessory pack 202. In one embodiment, the accessory pack 202 may be removed from the ski boot 210 by unlatching the buckles 204 and 206. Each buckle comprises a latch 212, grooved teeth (not shown), and a loop 214 for grabbing into the grooved teeth. When the two latches 212 associated with buckles 204 and 206 are lifted up, the associated loops 214 disengage from the grooved teeth and the accessory pouch 202 may be lifted away from and detach from the ski boot 210.

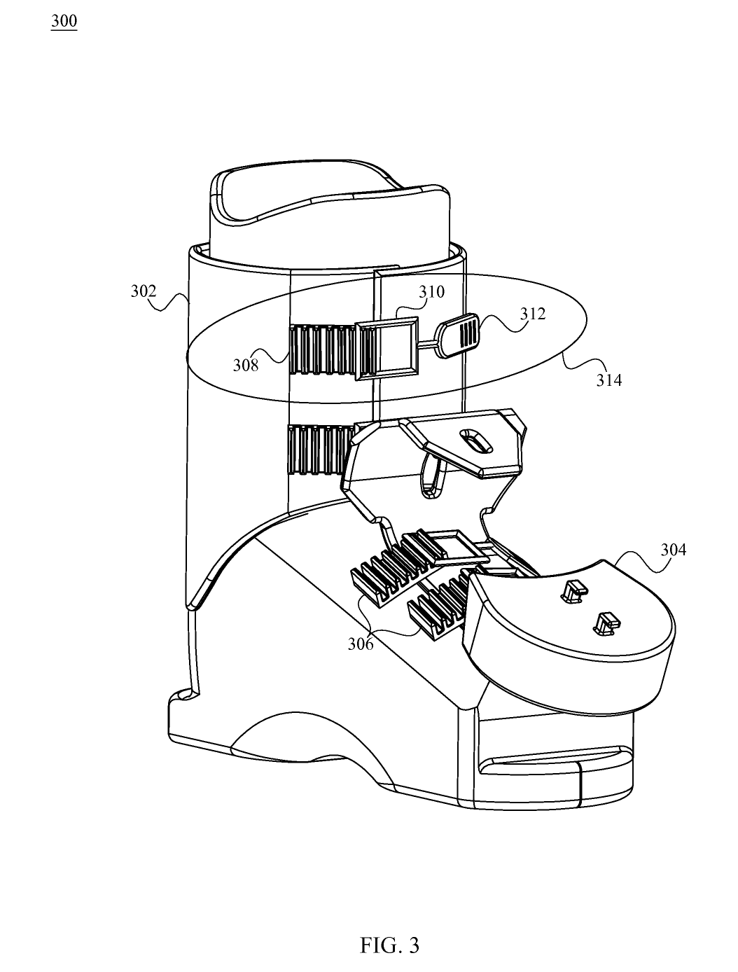

FIG. 3 illustrates a different perspective view 300 of an accessory pack coupled to a ski boot. In this view, an accessory pack 304 is coupled to a ski boot 302 by a pair of buckles 306. As described in FIG. 2, buckles may comprise grooved teeth. In this illustration, a buckle 314 comprises grooved teeth 308, a loop 310, and a latch 312. The grooved teeth 308 accept the loop 310 into one of the grooves. To disengage the buckle 314, the latch 312 is lifted upward and the loop 310 disengages from the groove.

In another embodiment, and as an additional means for maintaining the accessory pack 304 in a stable position against the ski boot 302, an adhesive may be used. The adhesive may reside between at least a portion of the backside of the accessory pack 304 that is in direct or indirect contact with the ski boot 302. In one embodiment, the adhesive may consist of Velcro™, rubber, or a more permanent solution such as cyanoacrylate glue, contact cement, or Gorilla Glue™, to name a few.

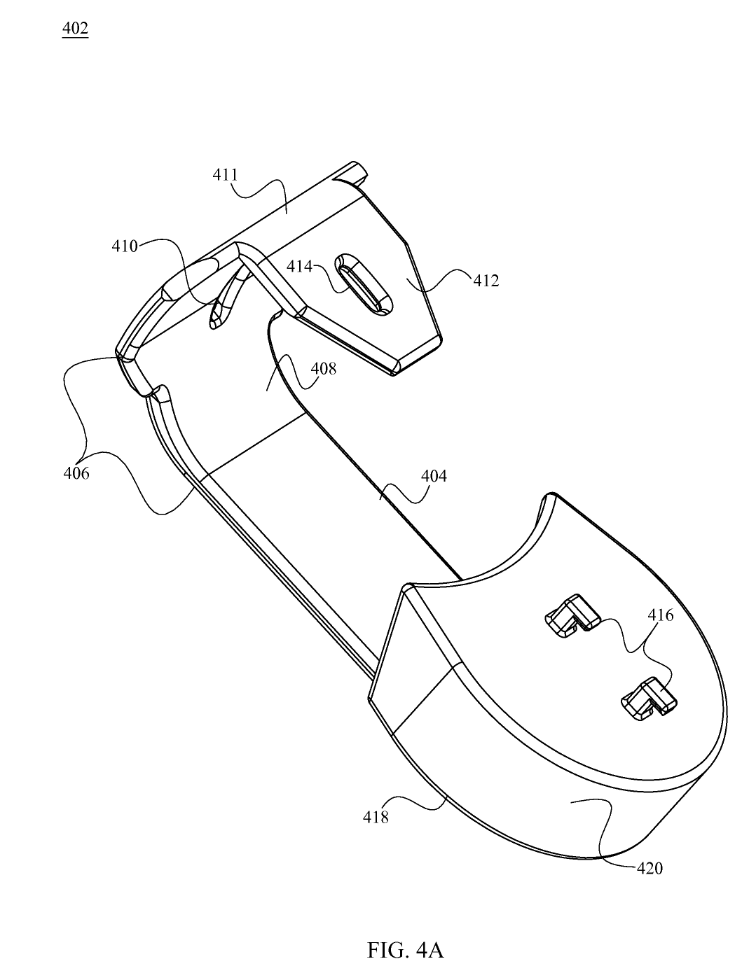

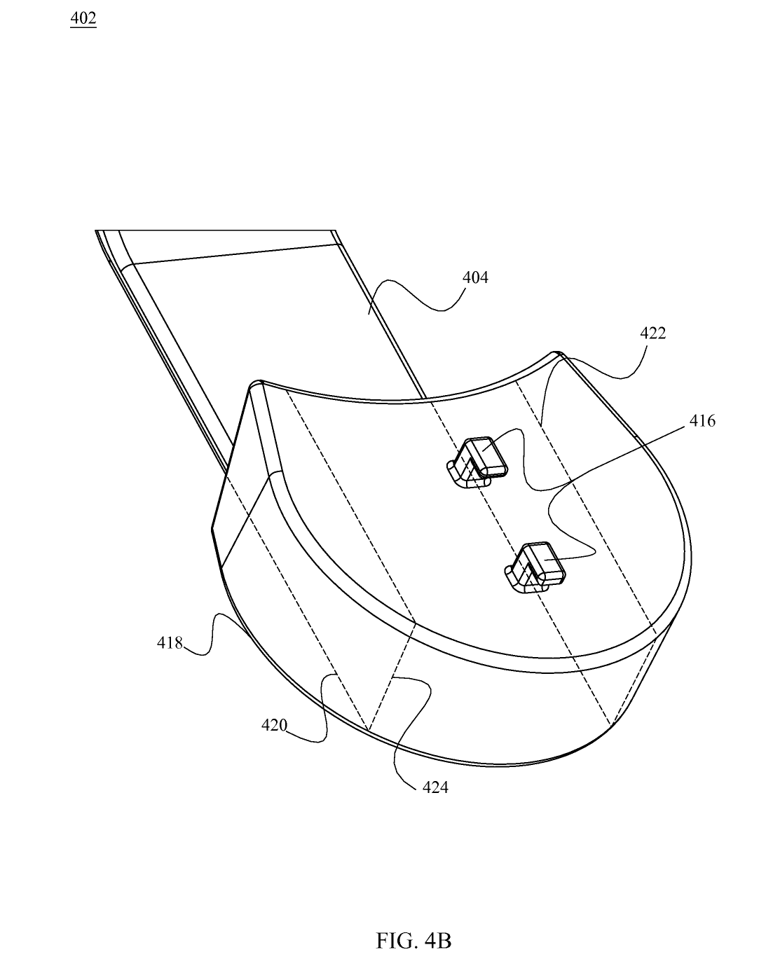

FIG. 4A illustrates a perspective view of an accessory pack and a plurality of features described therein. In one embodiment, an accessory pack 402 comprises a plurality of parts, however the accessory pack 402 may be a single piece comprised of one or more molded parts. In one embodiment, the accessory pack's 402 material may include a high performance thermoplastic elastomer (“TPE”) such as Santoprene™, Kraton™, and C-Flex™, to name a few. In another embodiment, the accessory pack's 402 material may include commercial grade Polyvinyl Chloride (“PVC”), rubber, cloth (e.g., cotton, polyester, or rayon), leather, or other plastics. Those skilled in the art can appreciate that other materials may be used without deviating from the scope and spirit of this invention.

In one embodiment, the accessory pack 402 comprises three primary components: a backbone 404, a hood 406, and a pouch 418. The backbone 404 is the base piece in which both the hood 406 and the pouch 418 affix. As illustrated in FIGS. 1-3, the backbone 404 is also the contact point where the accessory pack 402 may couple to a ski boot (not shown) or other footwear. In one embodiment, the backbone 404 may have a Durometer rating higher in numeric value than other components of the accessory pack 402. In another embodiment, all the components of accessory pack 402 may share the same Durometer rating, with some portions of the accessory pack 402 having varying thicknesses compared to other portions. For clarification purposes, a Durometer rating is a number denoting the hardness and durability of a material. A lower number would indicate a softer nature for the substance, while a higher number would indicate the material is harder and less susceptible to bending or stretching.

The pouch 418 component of the accessory pack 402 may serve as a storage unit for placing one or more accessories within the interior (not shown) of the pouch 418. In one embodiment, the pouch 418 may have a Durometer rating lower than the backbone 404, wherein the material of the pouch 418 may be pliable, expandable, and able to accept accessories larger than the pouches' 418 original internal dimensions. In an example, the pouch may be useful for storing one or more of the following: water bottle, flask, wallet, eyeglasses, food, energy bars, first aid kit, knife, keys, pepper spray, and a flashlight, etc. Other items may be stored without deviating from the scope of the invention. The size, shape and thickness of the pouch 418 may vary, without limitation. In one embodiment, and as illustrated in FIGS. 1-9, the pouch 418 resembles a U-shaped design with a rounded bottom. In this embodiment, the pouch is approximately 2″ to 6″ long, 2.5″ to 4″ wide, and 1″ to 2″ deep. The pouch 418 may be expandable due to its material having a low Durometer rating. As such, items larger than the pouch's 418 physical dimensions may fit inside the pouch's 418 interior.

In another embodiment, the pouch 418 may have a square or rectangular shape with a flat bottom and sidewalls. The dimensions and shapes listed above are merely examples and should not be construed as limiting in any way. As such, other dimensions and shapes may be used without deviating from the scope of the invention.

The pouch 418 also comprises one or more pouch hooks 416. The pouch hooks 416 may be used for assisting the hood 406 in coupling to the pouch 418. In one embodiment, the pouch hooks 416 are L-shaped, however, other shapes or designs may be used. In one embodiment, the pouch hooks 416 are part of the same mold, and thus the same Durometer rating, as the pouch 418. In one embodiment, the pouch hooks 416 have a higher Durometer rating than the pouch 418. As such, the pouch hooks 416 may be over-molded onto the pouch 418. This may allow for the pouch hooks 416 to resist bending if the hood 406 is stretched tight when coupled to the pouch 418 due to a large accessory (e.g., water bottle) stored in the pouch 418.

The hood 406 comprises a rear hood portion 408, a hood opening 410, a top hood portion 411, a front hood portion 412, and hood slot 414. In one embodiment, the rear hood portion 408, the top hood portion 411, and the front hood portions 412 form a U-shape to help prevent contents stored in the pouch 418 from falling out, when the hood 406 is coupled to the pouch 418.

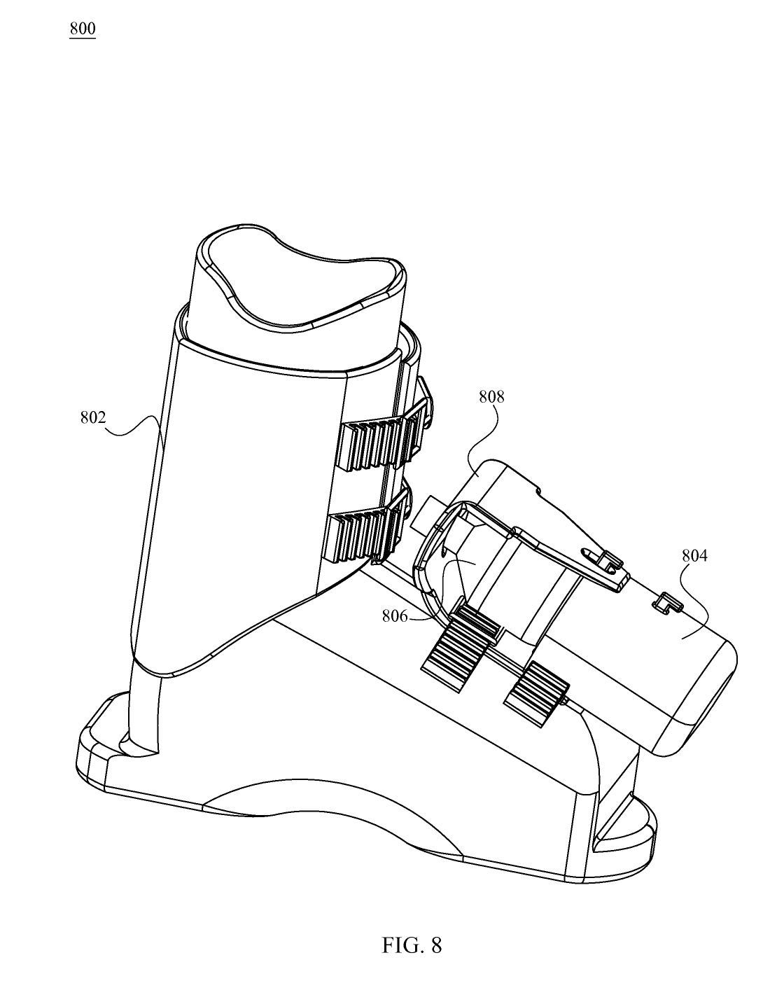

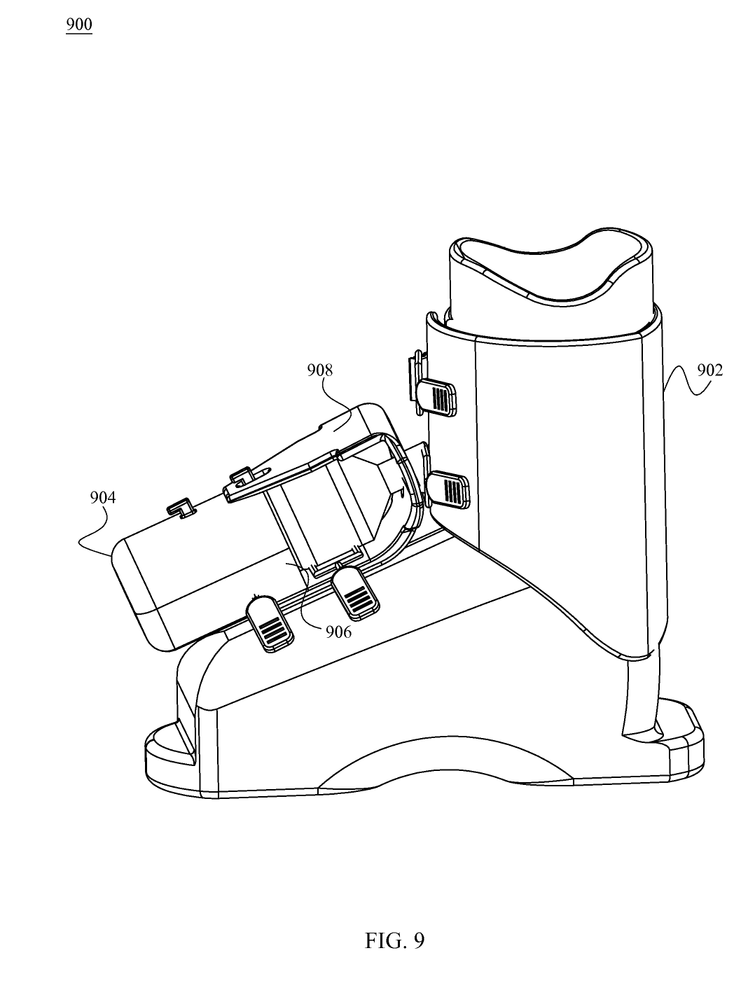

The hood opening 410 is a physical opening in the top hood portion 411 of the hood 406. In one embodiment, the hood opening 410 provides for an accessory (not shown) resting inside the pouch 418 to protrude through the top of the hood 406. Such examples of an accessory may include a water bottle or a flask. FIGS. 8 and 9 illustrate examples of a water bottle protruding through a hood opening 410.

The hood slot 414, located on the front hood portion 412, is a physical opening that may be used for receiving a pouch hook 416, when the hood 406 is brought down over the pouch 418. If there is a plurality of pouch hooks 416, a different hook 416 may be used depending on the contents being stored in the pouch 418 and how tight the user wishes to keep the contents.

In one embodiment, each of the backbone 404, the hood 406, and the pouch 418 have differing Durometer ratings and thus are of three distinct molded parts and created from three distinct tooling apparatuses.

In one embodiment, the backbone is the first molded part, with both the hood 406 and the pouch 418 being the second and third molded parts, respectively. Both the second and third molded parts are over-molded onto the first molded part. In another embodiment, the hood 406 and the pouch 418 share the same Durometer rating and may come from the same mold. In another embodiment, the backbone 404 and the pouch hook(s) 416 may have the same Durometer rating and may be of the same mold. In another embodiment, the backbone 404, the hood 406, and the pouch 418 have the same Durometer rating, are from a single tooling apparatus, and thus a single molded part. However, some portions of one or more of the components may be thicker in some areas. For example, the sides of the pouch 418 may be thicker than the rest of the pouch, thus adding rigidity to the pouch.

FIG. 4B illustrates a close-up view of a backbone extending into a pouch. In one embodiment, the backbone 404 may extend down to the bottom 420 of the pouch 418, up the pouch's front 424, and across the pouch's top 422. An advantage of this embodiment may be to add overall rigidity to the pouch 418, as the Durometer rating of the backbone may be higher than the remainder of the pouch 418. In this embodiment, the pouch hooks 416 may also be part of the same molded part, thus adding to the rigidity of the hooks 416.

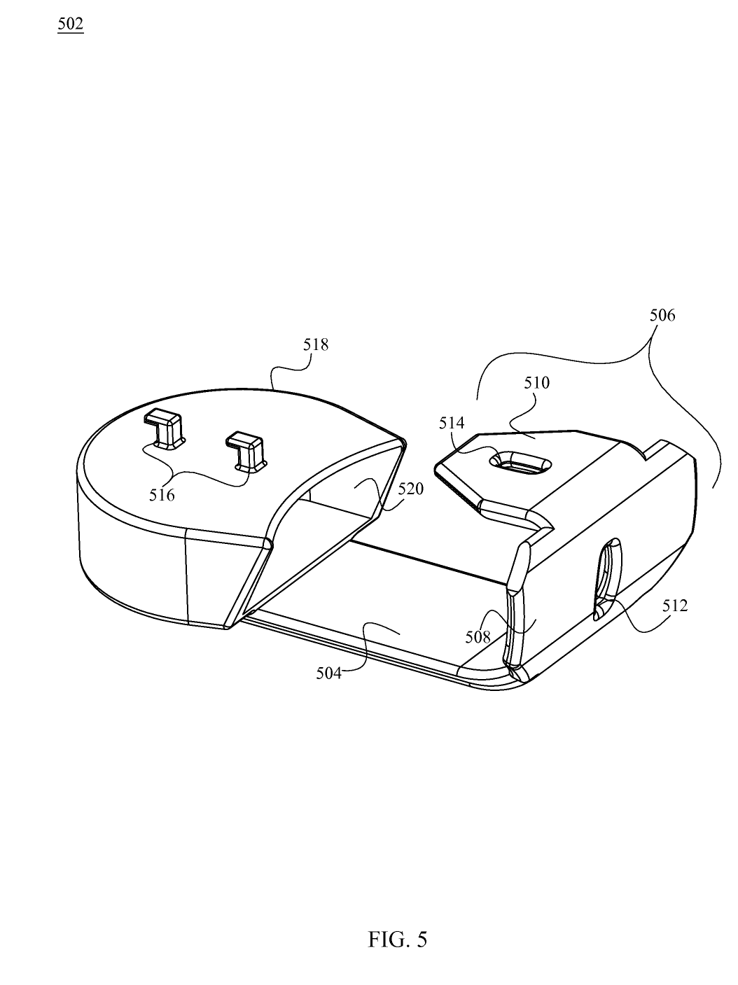

FIG. 5 illustrates a different perspective view of an accessory pack and a plurality of features. An accessory pack 502 is illustrated as having three main components: a backbone, 504, a hood 506, and a pouch 518. The hood 506 comprises a rear hood portion (not shown), a top hood portion 508, and a front hood portion 510. The hood 506 further comprises a top opening 512 and a hood slot 514. The pouch 518 comprises pouch hooks 516 and a pouch interior 520 where one or more accessories may be stored entirely within the interior 520 or protrude beyond the interior's 520 boundaries upwards.

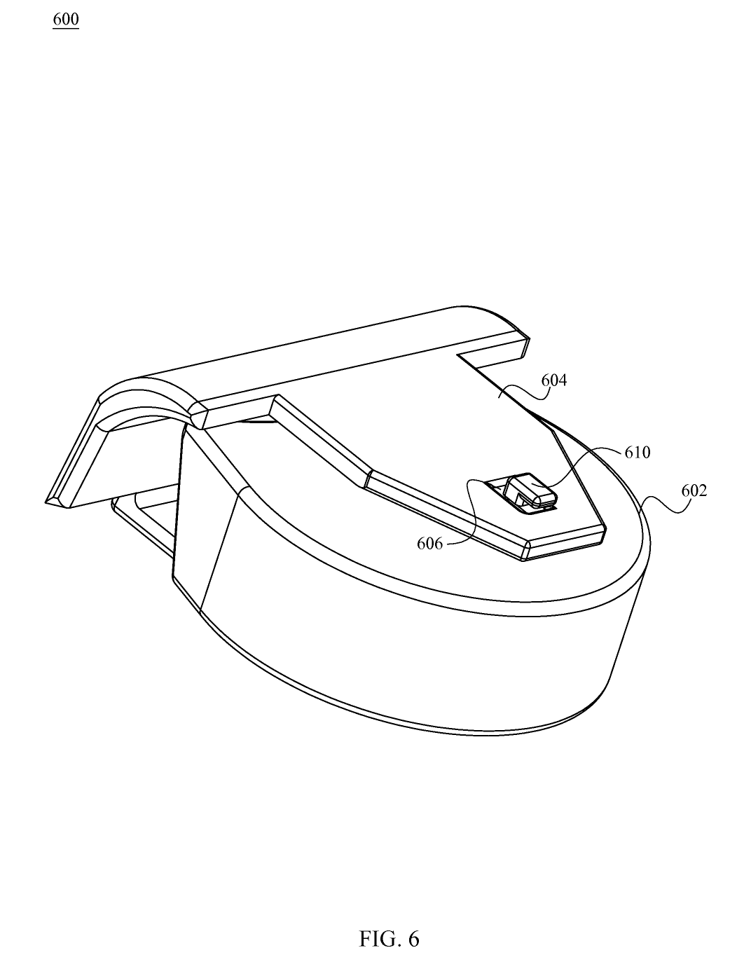

FIG. 6 illustrates a perspective view of a closed accessory pack. An accessory pack 600 at least comprises a pouch 602 and a hood 604. The hood 604 is placed over the top of and secured to the pouch 602 by means of a hood slot 606 and a pouch hook 610. The pouch hook 610 may be coupled to the pouch 602. The hood slot 606 may be configured to receive the pouch hook 610 and maintain the hood 604 in a closed position.

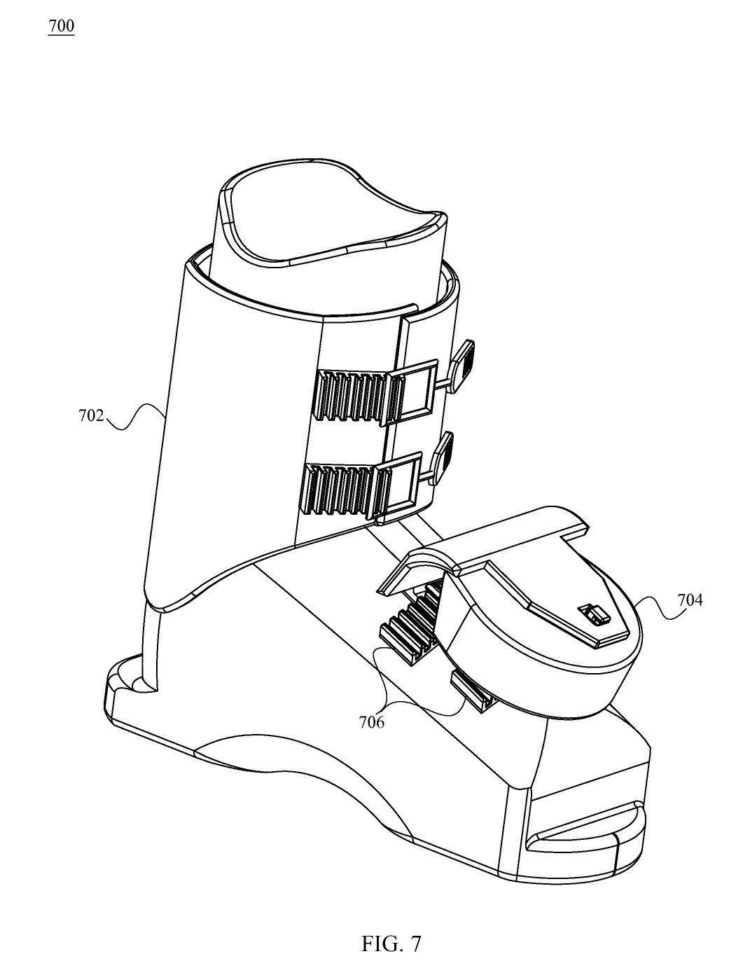

FIG. 7 illustrates a perspective view 700 of a closed accessory pack coupled to a ski boot. A ski boot 702 is shown with an accessory pack 704 coupled thereto. The accessory pack 704 couples to the ski boot by a pair of buckles 706. The user of the accessory pack 704 may choose to vary the vertical position, relative to the buckles 706, of the accessory pack 704. In other words, the vertical center of the accessory pack 704 is roughly over the bottom buckle 706. Alternatively, in FIG. 1, the accessory pack 104 is positioned substantially lower relative to the buckles 106.

FIG. 8 illustrates a perspective view 800 of an accessory pack securing a water bottle, while coupled to a ski boot. A ski boot 802 is shown with an accessory pack 804 coupled thereto. The accessory pack 804 secures a water bottle 806. Differing liquid containers may be substituted for a water bottle such as a THERMOS or other insulated containers capable of keeping interior contents hot or cold. In one embodiment, the Durometer rating of at least a portion of the accessory pack's 804 material is low enough such that the pack 804 is pliable enough to stretch to the shape of the water bottle. Yet, the accessory pack 804 may return to its original shape once the water bottle 806 is removed. Additionally, a top portion of the accessory pack 804 has a hood opening 808 to permit the top of the water bottle 806 to protrude through the top of the accessory pack 804.

FIG. 9 illustrates a different perspective view 900 of an accessory pack securing a water bottle, while coupled to a ski boot. A ski boot 902 is shown with an accessory pack 904 coupled thereto. The accessory pack 904 secures a water bottle 906. A top portion of the accessory pack 904 has a hood opening 908 to permit the top of the water bottle 906 to protrude through the top of the accessory pack 904.

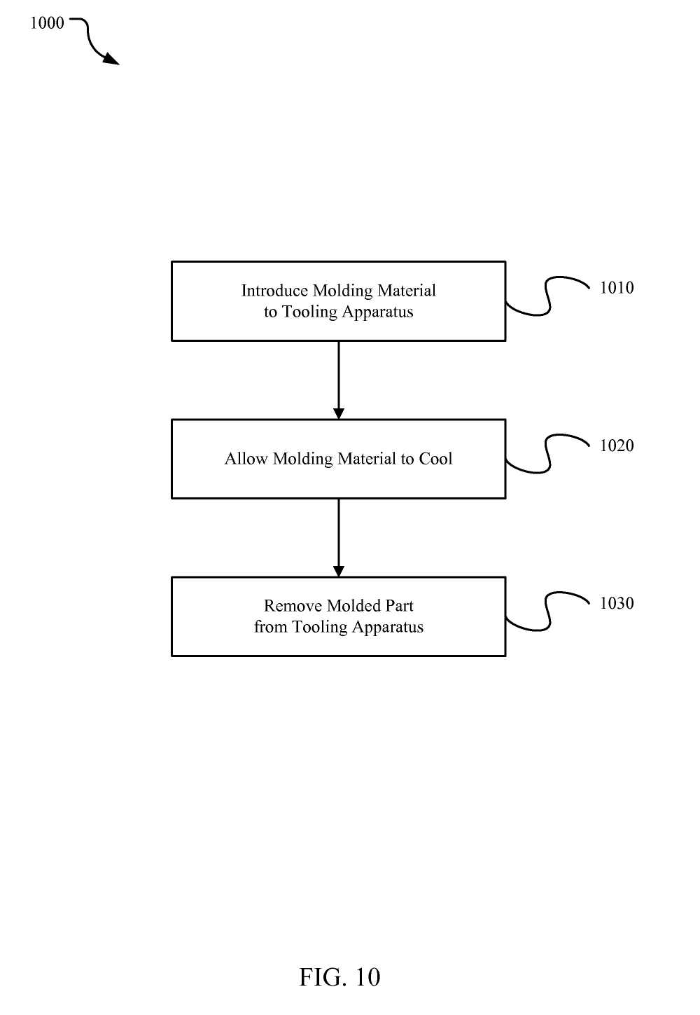

FIG. 10 is a flowchart describing the steps 1000 for manufacturing an accessory pack. In one embodiment, a method for manufacturing an accessory pack begins with an introduction step 1010 whereby a molding material is introduced into a tooling apparatus. In one embodiment, the molding material may be TPE or commercial grade PVC, to name a few. The type of molding introduction may vary. In one embodiment, the molding material may be introduced to the tooling apparatus through injection molding, poured molding, or silicon molding. However, other means for introducing the molding material may be used without deviating from the scope of the invention. In one embodiment, the tooling apparatus comprises a core and a cavity wherein the core aligns with the cavity by a polarity of pins. In one embodiment, the tooling apparatus' design includes all of the components of an accessory pack (e.g., the backbone, the hood, the pouch, and the pouch hooks.) The distance between the surfaces of the core and the cavity may be uniform, such that the thickness of a resulting accessory pack are also uniform. In another embodiment, the distance between the surface of the core and cavity may vary, such that the resulting accessory pack may have thicker portions than other portions. Once the molding material is introduced into the tooling apparatus, the material fills in the gaps between the core and the cavity.

Next, a cooling step 1020 occurs, whereby the molding material is given time to cool. This process may be accomplished through one or more cooling means such as air, water or other coolants. In one embodiment, the tooling apparatus may include cooling channels whereby cooling fluids or air may be introduced into the channels as a means for cooling the molding material as it hardens.

Lastly, a removal step 1030 occurs, whereby the now hardened molded part is removed from the tooling apparatus. The molded part is the resulting accessory pack.

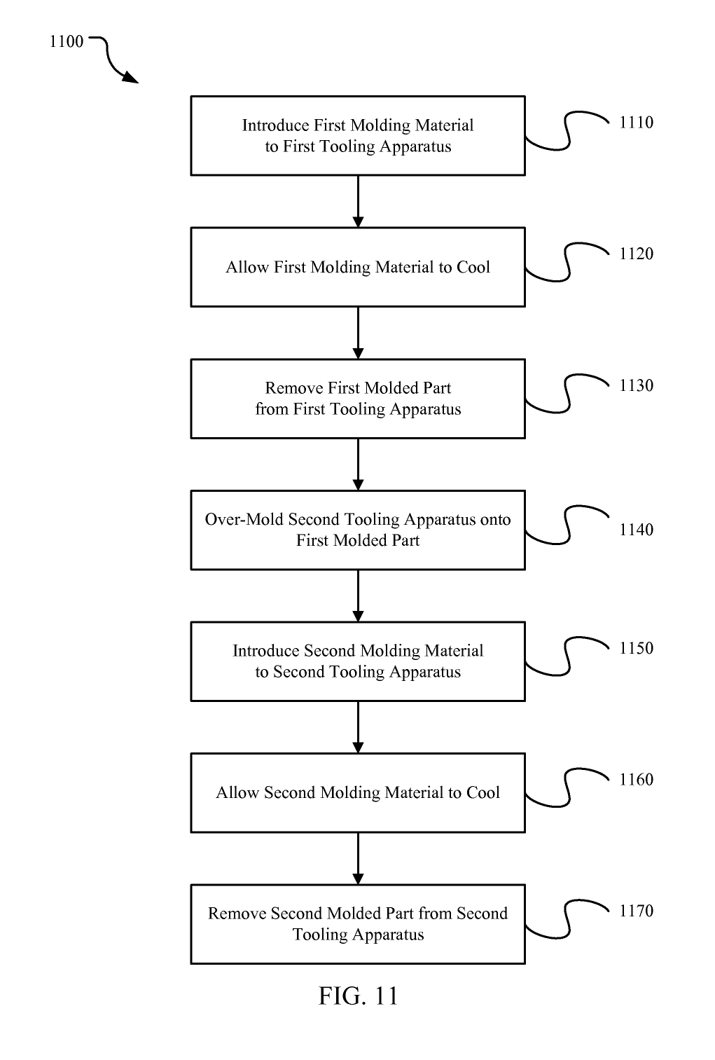

FIG. 11 is a flowchart describing the steps 1100 for manufacturing an accessory pack. In one embodiment, a method for manufacturing an accessory pack begins with a first introduction step 1110 whereby a first molding material is introduced into a first tooling apparatus. The type of molding introduction may vary. In one embodiment, the molding material may be introduced to the tooling apparatus through injection molding, poured molding, or silicon molding. However, other means for introducing the molding material may be used without deviating from the scope of the invention. The molding material may be TPE or commercial grade PVC, to name a few. In one embodiment, the first tooling apparatus comprises a first core and a first cavity wherein the first core aligns with the first cavity by a first polarity of pins. In one embodiment, the first tooling apparatus' design includes the backbone, a portion of the pouch, and the pouch hooks of an accessory pack. In this embodiment, the backbone is extended to comprise a portion of the back, bottom and top of the pouch, as illustrated in FIG. 4B. Once the first molding material is introduced into the first tooling apparatus, the first material fills in the gaps between the first core and the first cavity.

Next, a first cooling step 1120 occurs, whereby the first molding material is given time to cool. This process may be accomplished through one or more cooling means such as air, water or other coolants. In one embodiment, the first tooling apparatus may include cooling channels whereby cooling fluids or air may be introduced into the channels as a means for cooling the first molding material as it hardens.

Next, a first removal step 1130 occurs, whereby the now hardened first molded part is removed from the first tooling apparatus. The first molded part is the backbone, a portion of the pouch, and the pouch hooks. The first molded part has a first Durometer rating.

Next, an over-mold step 1140 occurs, whereby a second tooling apparatus is over-molded onto the first molded part. In one embodiment, the second tooling apparatus' design includes the remainder of the pouch and the hood. In one embodiment, the second tooling apparatus is positioned relative to the first molded part such that a resulting second molded part fuses to the first molded part, thus resulting in a single molded part.

Next, a second introduction step 1150 occurs, whereby a second molding material is introduced into the second tooling apparatus. The second molding material may be TPE or commercial grade PVC, to name a few. In one embodiment, the second tooling apparatus comprises a second core and a second cavity wherein the second core aligns with the second cavity by a second polarity of pins. Once the second molding material is introduced into the second tooling apparatus, the second material fills in the gaps between the second core and the second cavity. In one embodiment, one or more characteristics of the second molding material may be different from the first molding material such that the Durometer rating of the first molded part is different than the Durometer rating of the second molded part.

Next, a second cooling step 1160 occurs, whereby the second molding material is given time to cool. This process may be accomplished through one or more cooling means such as air, water or other coolants. In one embodiment, the second tooling apparatus may include cooling channels whereby cooling fluids or air may be introduced into the channels as a means for cooling the second molding material as it hardens and fuses with the first molded part.

Lastly, a second removal step 1170 occurs, whereby the now hardened second molded part has fused with the first molded part, resulting in a finished molded part. The finished molded part is removed from the second tooling apparatus. The finished molded part includes the hood, the backbone, the pouch and the pouch hooks. In one embodiment, the components comprising the first molded part have a higher Durometer rating than the components comprising the second molded part.

In the following description, for the purposes of explanation, numerous specific details are set forth in order to provide a thorough understanding of the present invention. It will be apparent, however, to one skilled in the art that the present invention may be practiced without some of these specific details. For example, while various features are ascribed to particular implementations, it should be appreciated that the features described with respect to one implementation may be incorporated with other implementations as well. By the same token, however, no single feature or features of any described implementation should be considered essential to the invention, as other implementations of the invention may omit such features.

The logical operations may be performed in any order, unless explicitly claimed otherwise or a specific order is inherently necessitated by the claim language. The above specification, examples, and data provide a complete description of the structure and use of example implementations of the invention. Since many implementations of the invention can be made without departing from the spirit and scope of the invention, the invention resides in the claims hereinafter appended. Furthermore, structural features of the different implementations may be combined in yet another implementation without departing from the recited claims.

What is claimed is:

1. An accessory pack for attaching to a footwear apparatus, the accessory pack comprising:
a backbone configured for fitting under a fastening mechanism of the footwear apparatus; and
a pouch having an interior volume configured to receive one of more accessories, the pouch coupled to a first end of the backbone.

2. The accessory pack of claim 1, further comprising a hood coupled to a second end of the backbone, the hood configured for maintaining the one or more accessories in the pouch when the hood is folded over and attached to the pouch.

3. The accessory pack of claim 2, further comprising:
one or more pouch hooks positioned on a front face of the pouch, the one or more pouch hooks configured for assisting the hood in attaching to the pouch;
a hood opening positioned on a top portion of the hood, the hood opening configured for allowing one or more accessories to protrude through the top of the accessory pack; and
a hood slot positioned on a bottom potion of the hood, the hood slot configured to receive one or more pouch hooks to assist with attaching the hood to the pouch.

4. The accessory pack of claim 3, wherein at least the backbone, the pouch, and the hood are manufactured from a core and a cavity wherein the core aligns to the cavity with a plurality of pins.

5. The accessory pack of claim 3, wherein the backbone is manufactured from a first core and a first cavity wherein the first core aligns with the first cavity with a first plurality of pins, and wherein the pouch and the hood and manufactured from a second core and a second cavity wherein the second core aligns with the second cavity with a second plurality of pins.

6. The accessory pack of claim 4, wherein the backbone, the pouch, and the hood are manufactured from the core and cavity as a single molded part having a first Durometer rating.

7. The accessory pack of claim 5, wherein the one or more pouch hooks are further manufactured from the core and cavity and are part of the single molded part, wherein the pouch hooks have a first thickness greater than the thickness of the remainder of the accessory pack.

8. The accessory pack of claim 5, wherein the backbone is manufactured from the first core and the first cavity as a first molded part having a first Durometer rating, and the pouch and the hood are manufactured from the second core and the second cavity as a second molded part having a second Durometer rating having a different numeric value than the first Durometer rating, wherein the second molded part is over-molded onto the first molded part.

9. The accessory pack of claim 6, wherein the pouch comprises at least a left side and a right side having a first thickness, wherein the first thickness is less than a thickness of a remainder of the accessory pack.

10. The accessory pack of claim 8, wherein the backbone extends down at least a center portion of a backside of the pouch, across at least a center portion of a bottom of the pouch and up at least a center portion of a front of the pouch.

11. The accessory pack of claim 10, wherein the backbone extends to substantially cover the entirety of the backside of the pouch, the entirety of the bottom of the pouch and the entirety of the front of the pouch.

12. The accessory pack of claim 11, wherein the one or more pouch hooks are further manufactured from the first core and first cavity and are part of single molded part, wherein the pouch hooks have a thickness greater than a thickness of the remainder of the accessory pack.

13. The accessory pack of claim 4, wherein a material of at least one of the backbone, the pouch, or the hood is high performance thermoplastic elastomer.

14. The accessory pack of claim 4, wherein a material of at least one of the backbone, the pouch, or the hood is commercial grade Polyvinyl Chloride.

15. The accessory pack of claim 7, wherein a material of at least one of the backbone, the pouch, or the hood is high performance thermoplastic elastomer.

16. The accessory pack of claim 7, wherein a material of at least one of the backbone, the pouch, or the hood is commercial grade Polyvinyl Chloride.

17. A method for manufacturing an accessory pack for attaching to a footwear apparatus, the method comprising the steps of:
introducing a molding material into a tooling apparatus to create a molded part, the tooling apparatus comprising a core and a cavity, wherein the core aligns with the cavity by a polarity of pins; and
wherein the molded part comprises:
a backbone configured for fitting under a fastening mechanism of the footwear apparatus;
a pouch having an interior volume configured to receive one of more accessories, the pouch coupled to a first end of the backbone; and
a hood coupled to a second end of the backbone, the hood configured for maintaining the one or more accessories in the pouch when the hood is folded over and attached to the pouch.

18. The method of claim 17, wherein the molded part further comprises:
one or more pouch hooks positioned on a front face of the pouch, the one of more pouch hooks configured for assisting the hood in attaching to the pouch;
a hood opening positioned on a top portion of the hood, the hood opening configured for allowing one or more accessories to protrude through the top of the accessory pack; and
a hood slot positioned on a bottom potion of the hood, the hood slot configured to receive one or more pouch hooks to assist with attaching the hood to the pouch.

19. The method of claim 18, wherein the pouch comprises at least a left side and a right side having a first thickness, wherein the first thickness is less than a thickness of a remainder of the accessory pack.

20. The method of claim 19, wherein the one or more pouch hooks have a second thickness greater than the thickness of the remainder of the accessory pack.

21. The method of claim 20, wherein the molding material is a high performance thermoplastic elastomer.

22. The method of claim 20, wherein the molding material is a commercial grade Polyvinyl Chloride.

23. A method for manufacturing an accessory pack for attaching to a footwear apparatus, the method comprising the steps of:
introducing a first molding material into a first tooling apparatus to create a first molded part, the first tooling apparatus comprising a first core and a first cavity, wherein the first core aligns with the first cavity by a first polarity of pins;
wherein the first molded part comprises a backbone configured for fitting under a fastening mechanism of the footwear apparatus;
wherein the first molded part has a first Durometer rating;
introducing a second molding material into a second tooling apparatus to create a second molded part, the second tooling apparatus comprising a second core and a second cavity, wherein the second core aligns with the second cavity by a second polarity of pins;
wherein the second molded part comprises:
a pouch having an interior volume configured to receive one or more accessories, the pouch coupled to a first end of the backbone; and
a hood coupled to a second end of the backbone, the hood configured for maintaining the one or more accessories in the pouch when the hood is folded over and attached to the pouch;
wherein the second molded part has a second Durometer rating different than the first Durometer rating; and
wherein the second molded part is over-molded on the first molded part.

24. The method of claim 23, wherein the molded part further comprises:
one or more pouch hooks positioned on a front face of the pouch, the one of more pouch hooks configured for assisting the hood in attaching to the pouch;
a hood opening positioned on a top portion of the hood, the hood opening configured for allowing one or more accessories to protrude through the top of the accessory pack; and
a hood slot positioned on a bottom potion of the hood, the hood slot configured to receive one or more pouch hooks to assist with attaching the hood to the pouch.

25. The method of claim 24, wherein the backbone runs down at least a center portion of a backside of the pouch, across at least a center portion of a bottom of the pouch, and up at least a center portion of a front of the pouch.

26. The method of claim 25, wherein the backbone expands to substantially cover the entirety of the backside of the pouch, the entirety of the bottom of the pouch and the entirety of the front of the pouch.

27. The method of claim 23, wherein the first and second molding material is a high performance thermoplastic elastomer.

28. The method of claim 23, wherein the first and second molding material is a commercial grade Polyvinyl Chloride.

29. The method of claim 23, wherein a mixture of the first molding material produces a different Durometer rating than a mixture of the second molding material.
